(19) United States
(12) Patent Application Publication
(10) Pub. No.: US 2026/0329471 A1
(43) Pub. Date: Oct. 22, 2026

(54) METHOD FOR CHANGING THE MEMORY CONTENT OF A MAIN MEMORY OF A MICROCONTROLLER WITHOUT A SEPARATE MEMORY MANAGEMENT UNIT, USE THEREOF, MICROCONTROLLER AND VEHICLE

(71) Applicant: MERCEDES-BENZ GROUP AG, Stuttgart (DE)

(72) Inventors: Thorsten WILMER, Sindelfingen (DE); Sebastian WAGNER, Renningen (DE); Mark KIRICHENKO, Berlin (DE); Thomas BOLEMANN, Ostelsheim (DE)

(21) Appl. No.: 19/120,436

(22) PCT Filed: Sep. 18, 2023
(86) PCT No.: PCT/EP2023/075626

§ 371 Date: Apr. 11, 2025

(30) Foreign Application Priority Data
Oct. 14, 2022 (DE) 10 2022 003 789.0

(51) Int. Cl. G06F 3/06

(52) U.S. Cl. CPC G06F 3/0655; G06F 3/0604; G06F 3/0673

(57) ABSTRACT

A method for changing the memory content of a main memory of a microcontroller without a separate memory management unit is provided. A part of the main memory is occupied by a base firmware. At least one component block is also written into the main memory when the base firmware is inserted into the main memory. The component block includes code components for providing at least one firmware component and/or at least one application program component and memory management information. To change at least one part of the code components of at least one component block, a processor of the microcontroller processes the memory management information and writes information to be written into the main memory at locations defined by the memory management information, and the memory management information of the changed component block is updated.

### BACKGROUND AND SUMMARY OF THE INVENTION

Exemplary embodiments of the invention relate to a method for changing the memory content of a main memory of a microcontroller without a separate memory management unit, the use of such a method, a microcontroller, and a vehicle comprising such a microcontroller.

Microcontrollers, sometimes also referred to as system-on-a-chip (SoC), can be found in a wide variety of devices and machines for solving a wide range of tasks. For example, microcontrollers are used as control devices for household appliances or also integrated into vehicles to provide vehicle functions.

The control commands to be implemented by a microcontroller are stored in the form of source codes on a storage medium. As is generally the case for information technology systems, it may be necessary to install software updates, for example in order to close security gaps, fix bugs or provide new functionalities. Microcontrollers can have a memory management unit (MMU), which serves to convert the virtual addresses of each individual process processed by the microcontroller into physical addresses of a memory medium used. If software updates are installed, the corresponding program code stored in the storage medium must be changed. This is easily possible using the memory management unit.

The tasks to be performed by a microcontroller are typically comparatively simple. In addition, microcontrollers should be manufactured cost-effectively. For these reasons, it is important to minimize the complexity of microcontrollers as much as possible. The integration of memory management units into a microcontroller is therefore often dispensed with. In this case, the installation of software updates is no longer readily possible. There is therefore a need to provide means that enable software updates to be installed on a microcontroller without a memory management unit.

A possible approach is known from DE 10 2011 106 078A1, which discloses a vehicle unit and a method for its operation. The vehicle unit is a computing unit that has the ability to independently carry out a software repair. The vehicle unit has a microkernel architecture for this purpose. For this purpose, the operating system is partitioned into a main operating system unit, a crypto unit, and a supervision unit. In addition, a policy unit can optionally be provided. A basic version of the operating system is stored on a flash drive as a backup image, wherein the crypto unit and the supervision unit monitor the operation of the main operating system unit and reinstall the operating system from the backup image in the event of malfunctions. By providing the crypto unit and the supervision unit, there is no need to provide separate memory controllers. However, the disadvantage here is that the vehicle unit disclosed here is based on the microkernel architecture and thus has the associated disadvantages such as reduced execution speed, high synchronization effort of the user processes, and limited hardware access for the executed processes. The function of controlling the memory is carried out by the supervision unit and the crypto unit, which are designed as read-only units. This greatly limits the flexibility when adjusting the vehicle unit to changed boundary conditions, since the memory management logic cannot be adjusted.

Exemplary embodiments of the present invention are directed to an improved method for changing the memory content of a main memory of microcontroller without a separate memory management unit, by means of which a particularly easy, reliable and flexible change of the memory content is made possible.

A generic method for changing the memory content of a main memory of a microcontroller without a separate memory management unit, wherein a part of the main memory is occupied by a base firmware, is developed according to the invention by
at least one component block also being written into the main memory when the base firmware is inserted into the main memory, wherein the component block comprises code components for providing at least one firmware component and/or at least one application program component and memory management information; and
for changing at least one part of the code components of at least one component block, a processor of the microcontroller processing the memory management information and writing information to be written into the main memory at locations defined by the memory management information, and the memory management information of the changed component block being updated.

Here, the main memory of the microcontroller is not the working memory, also known as random access memory (RAM), but a main data carrier that contains the source code of the basic firmware. For example, the main memory can be a flash memory element. In order to simplify the structure of the microcontroller, the integration of a memory management unit, i.e., an MMU, has been dispensed with. With the aid of the method according to the invention, it is nevertheless possible to change the content of the main memory after it has been initially loaded with data. Here, the instructions for activating the main memory are themselves contained in the modifiable part of the data structure, which enables particularly flexible adaptation of the control of the main memory. This enables particularly flexible use of the microcontroller even under changed boundary conditions.

Here, the basic firmware represents an unchangeable basic software framework for providing basic functions. Additional functions can then be added to this basic firmware in the form of one or more component blocks. In addition to supplementary firmware components, here application program components can also be written into a component block, which allows application programs to be provided by means of the microcontroller. There are fixed rules defined by the memory management information as to where information can be found in the component blocks that cause the microcontroller processor to access the respectively relevant locations of the main memory to change the memory content.

The information respectively to be written, for example software updates, can be communicated to the microcontroller externally. The microcontroller has suitable interfaces for this purpose. For example, a storage medium such as a USB stick or an SD card can be inserted into a suitable read slot, and the information to be written can be read from it. The microcontroller can also be integrated into an information technology network of several computing units and obtain the information to be written via this network. Here, a computing unit in this network can be designed as a communication module and thus also obtain information via the Internet, for example via mobile radio.

In this context, “writing” means deleting, adding to or overwriting existing information in the main memory. Here, new component blocks can optionally also be written into the main memory and appended to existing component blocks. Correspondingly, not only is the memory management information of the initial last component block in the chain of component blocks changed, but new memory management information is also defined for the newly created and appended component blocks.

Instead of new component blocks being added to an existing chain of basic firmware and component blocks, the complete content of the main memory can already be divided into the basic firmware and at least one component block. When changing the memory content, this one component block can then be successively divided into several component blocks. For example, if the main memory has a size of 256 MB and the basic firmware occupies 20 MB of this and a first component block, comprising supplementary firmware components, 60 MB, then the size of a second (placeholder) component block is 176 MB. This second 176 MB component block can then be divided into a new second and a third component block when the memory content of the main memory is changed, or it then breaks down into these component blocks. If, for example, 56 MB of further information is to be written into the main memory, the 176 MB are divided into the new second component block of 56 MB and the third component block of 120 MB. In this way, the available storage space on the main memory can be successively divided into component blocks.

An advantageous development of the method provides that the following structure is achieved for a respective component block:
a length section, defining the length of the region occupied by the respective component block on the main memory;
a text section comprising the code components for providing the at least one firmware component and/or at least one application program component;
an input interface section, defining which input interfaces are read out by the respective component block for reading input data;
an output interface section, defining which output interfaces are written by the respective component block for outputting output data; and
a parameter section defining an execution frequency of the firmware components and/or application program components that can be provided by a respective component block and application memory request information defining which memory size is occupied on a RAM of the microcontroller during the execution of a respective firmware component and/or application program component.

Here, the text section represents the relevant part of the respective component block for providing the firmware component or application program component. The text section thus contains the actual “payload”. The remaining sections then correspondingly represent the memory management information.

The length section describes the size of the content of the main memory described by the respective component block. A notation that can be processed for the design of the respective main memory is chosen here, for example a file size, a number of flash pages, an address range, or similar. Information is successively stored in the main memory such that a series or chain of described sections emerges. The microcontroller can then determine exactly where a respective component block begins and ends on the main memory by reading out the correspondingly described length of the parts described by the component blocks.

The programs or program parts provided by the respective component blocks optionally require input data to be read in and output data to be provided after they have been processed by the processor. The input interface section then contains the information defining which input data must be read in from which input interfaces. A component block can contain a single firmware component and/or a single application program component or several firmware components and/or several application program components. Each individual firmware component or each individual application program component then has its own interface definition, which input interfaces and which output interfaces are used. The output interface section is thus used to correspondingly define which output data is provided for each of these program components and a corresponding identifier of the output interfaces.

The parameter section communicates with the microcontroller at which execution frequency the individual program components contained in the component blocks are to be executed. In addition, the parameter section contains information on how much memory must be reserved on the RAM by the respective program component. This makes it possible to reliably provide sufficient memory on the RAM.

A respective component block, i.e., the individual program components contained in the component blocks, can respectively call up and use functions of the basic firmware. However, program components cannot directly call up other program components in other component blocks. Communication between the component blocks takes place via the corresponding input data and output data.

Here, the code components contained in the component blocks are to be compiled in such a way that the code is position-independent, since the sequence and position of the component block in the main memory is not known. Thus, the use of global or static variables is not permitted. All information that is relevant to a component block is transferred as a function call.

According to a further advantageous design of the method, variables representing output data that can be output by a respective component block are written to the RAM of the microcontroller when the microcontroller starts up. “When the microcontroller starts up” in this context means the execution of the basic firmware by the processor of the microcontroller when the microcontroller is started. Parts of the RAM are initially filled by the variables. These variables are representative of the output data that can be generated by the program components of the component blocks. This enables the respective program components to write the output data to the RAM even after it has been processed by the processor. These variables can be summarized as one or more swap files.

A further advantageous design of the method further provides that the following information is written into the RAM of the microcontroller for each component block during the start-up of the microcontroller, taking into consideration the respective memory management information:
a mapping structure defining at which locations of the RAM output data that can be generated by the respective component block is written and an allocation in which memory regions of the RAM input data required by the respective component block is stored;
a function sequence structure, defining a respective sequence of the functions to be processed by the processor to provide the firmware components and/or application program components that can be provided by the respective component block; and
for each firmware component and/or application program component of the respective component block: an output structure, defining output data to be written by the respective firmware component and/or application program component.

Here too, “when the microcontroller starts up” means the execution of the basic firmware by the processor when the microcontroller is started. The mapping structure here describes where the variables mentioned above are written into the RAM and which program component correspondingly generates which output data and reads in which input data. This enables each program component, i.e., a respective firmware component or application program component, to reliably read in and output the information to be processed.

The function sequence structure communicates with the microcontroller the order in which the program components contained in the component blocks to provide certain functionalities are to be carried out.

In other words, the output structure describes which variables are output by the respective program components.

An input interface or output interface can be defined by a unique name, a unique version identifier and a unique (file) size. Thus, the variables are transferred via the respective interfaces. The individual variables can have different sizes.

A pointer to the respective mapping structure is passed to each executed program component with each execution.

Here, zero pointers, also known as null pointers, can also be transferred such that individual program components can optionally be considered non-existent.

The sequence defined via the function sequence structure represents a function pointer. Initially, this function pointer is formed by the beginning of the respective text section, comprising the basic components of a respective program component.

When initializing the microcontroller, the basic firmware goes through the individual component blocks, reserves the regions of the RAM executed in the previous section and writes the pointers mentioned in the previous section in accordance with the mapping structure in the RAM.

According to a further advantageous design of the method according to the invention, a respective component block is granted direct hardware access to the hardware components of the microcontroller. Thus, direct access to the hardware of the microcontroller can be permitted or prohibited for the individual program components of the component blocks. The more program components have access to the hardware, the smaller the basic firmware can be designed.

Preferably, written access to the RAM is restricted before execution of the at least one firmware component and/or at least one application program component of a respective component block, such that only output data that can be output by the respective component block can be written to the RAM for the respective component block. In other words, the memory protection unit (MPU) can be configured before a component is executed such that only the respective part of the RAM into which the output data of the respective program component is written can be written. This ensures the “Freedom of Interference” required by ISO 26262.

An application according to the invention of a method described above provides for the use to perform a software update of a program stored in the main memory of the microcontroller, in particular to update the firmware of the microcontroller. With the aid of the method according to the invention, it is also possible to change the memory contents of the respective main memory of such microcontrollers that do not have a separate memory management unit. In this way, programs to be processed by the microcontroller can be updated or even new programs can be loaded. The firmware of the microcontroller can also be changed in a particularly advantageous way. For this purpose, the firmware is divided into basic firmware and firmware components provided in the component blocks. Here, the basic firmware provides basic instructions for controlling the hardware used in order to read out relevant interfaces and address hardware components. Additional functionalities are contained in the firmware components of the component blocks.

In addition, a microcontroller according to the invention is set up to execute a method described above.

According to the invention, a vehicle comprises at least one such microcontroller.

Further advantageous designs of the method according to the invention for changing the memory content of a main memory of a microcontroller without a separate memory management unit also emerge from the exemplary embodiments, which are described in more detail below with reference to the Figures.

### BRIEF DESCRIPTION OF THE DRAWING FIGURES

Here are shown:

FIG. 1 a schematized depiction of the contents of a main memory and a working memory of a microcontroller according to the invention; and

FIG. 2 a schematized depiction of the contents of a component block written into the main memory in addition to a basic firmware, divided into the contents of the main memory and the working memory.

### DETAILED DESCRIPTION

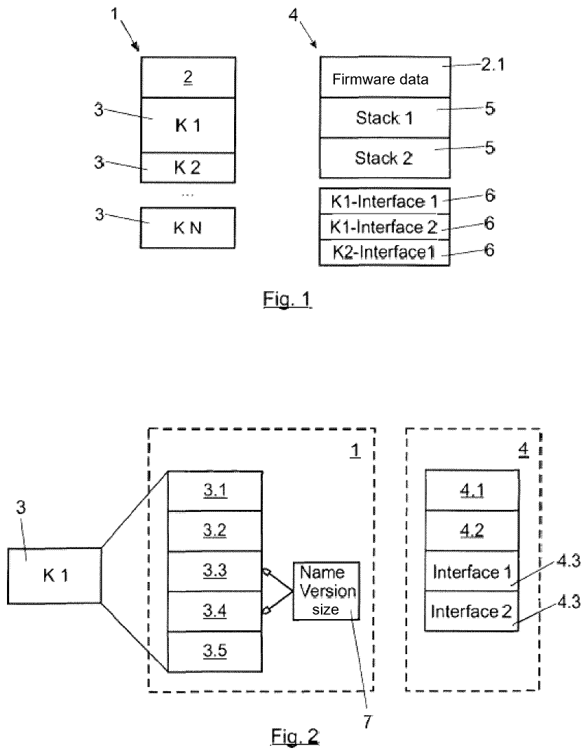

FIG. 1 shows a main memory 1 and the working memory, also referred to as random access memory (RAM) 4, of a microcontroller according to the invention. In particular, the main memory 1 is a flash memory element. Information is successively stored in the main memory 1. The information represents a source code for providing various programs. The information is strung together to form a chain.

A basic firmware 2 is shown, followed by at least one component block 3. In the exemplary embodiment shown in FIG. 1, the main memory has a plurality of component blocks 3 labelled K1 to K N. Here, the main memory 1 can have free memory, wherein further component blocks 3 are introduced into the main memory 1 when the memory content of the main memory 1 is changed according to a method according to the invention. It is also possible that the main memory 1 is already completely subdivided into component blocks 3. Here, there may also be a particularly large component block 3, which is then subdivided into further component blocks 3 when the content of the main memory 1 is changed. Such a component block 3 can be understood as a placeholder.

Furthermore, FIG. 1 shows the contents of the RAM 4. A basic firmware section 2.1 and at least one stack 5, also known as a swap file, can be seen. The compiled code to be executed by the processor of the microcontroller for corresponding programs and the data required by the respective programs for processing are stored in the stack 5. If the processor or the microcontroller is set up for parallel processing, also referred to as multithreading, a separate stack 5 can also be available for each task, as depicted.

Furthermore, interface information 6 can be found in the RAM 4, which describes which input interfaces and output interfaces are linked to each other and how for each program component, i.e., a firmware component and/or application program component, encompassed by a component block 3.

FIG. 2 once again shows the content written into the main memory 1 and the RAM 4 for a respective component block 3 in detail. Thus, each component block 3 (here exemplified as K 1) comprises information to be written into the main memory 1 in the form of a length section 3.1, a text section 3.2, an input interface section 3.3, an output interface section 3.4, and a parameter section 3.5.

The length section 3.1 defines the region occupied by the respective component block 3 on the main memory 1. Since the component blocks 3 are attached to each other as information in the form of a chain, the microprocessor is thus able to recognize the respective start and end of all component blocks 3 and can thus jump directly to the respective component block 3 on the main memory 1 for a written or read access.

The text section 3.2 represents the actual payload of component block 3 and contains the code sections for providing a respective firmware component or application program component. This is position-independent code, i.e., code that is compiled independently of position, since the sequence and position of the respective program component from component block 3 is not inherently known.

The input interface section 3.3 describes which input data is requested by a respective program component. Correspondingly, the output interface section 3.4 describes which output data is generated by a respective program component. The input interface section 3.3 and the output interface section 3.4 can be described by an interface specification 7, which uniquely describes an identifier such as a name, a version reference and/or a size of the respective interface.

Finally, the parameter section 3.5 describes the frequency with which a respective program component of a respective component block 3 is executed by the microprocessor and how much memory size in the form of the respective stack 5 or a share of a corresponding stack 5 is requested by the respective program component on the RAM 4.

Furthermore, the RAM content of the respective component block 3 is shown. A mapping structure 4.1, a function sequence structure 4.2 and an output structure 4.3 can be seen for each program component.

The mapping structure 4.1 describes a structure of pointers to a respective input interface and output interface used by the component block 3. The function sequence structure 4.2 describes the order in which the respective program components covered by component block 3 are to be processed by the microprocessor. Finally, the output data is written in the respective output structures 4.3 after a respective program component has been processed.

Although the invention has been illustrated and described in detail by way of preferred embodiments, the invention is not limited by the examples disclosed, and other variations can be derived from these by the person skilled in the art without leaving the scope of the invention. It is therefore clear that there is a plurality of possible variations. It is also clear that embodiments stated by way of example are only really examples that are not to be seen as limiting the scope, application possibilities or configuration of the invention in any way. In fact, the preceding description and the description of the figures enable the person skilled in the art to implement the exemplary embodiments in concrete manner, wherein, with the knowledge of the disclosed inventive concept, the person skilled in the art is able to undertake various changes, for example, with regard to the functioning or arrangement of individual elements stated in an exemplary embodiment without leaving the scope of the invention, which is defined by the claims and their legal equivalents, such as further explanations in the description.

1-9. (canceled)

10. A method for changing memory content of a main memory of a microcontroller without a separate memory management unit, wherein a part of the main memory is occupied by a base firmware, the method comprising:
writing at least one component block into the main memory when the base firmware is inserted into the main memory, wherein the at least one component block comprises memory management information and code components for providing at least one firmware component or at least one application program component; and
for changing at least one part of the code components of at least one component block, a processor of the microcontroller processes the memory management information and writes information to be written into the main memory at locations defined by the memory management information, and the memory management information of the changed at least one component block is updated.

11. The method of claim 10, wherein the at least one component block comprises a plurality of component blocks, wherein each of the plurality of component blocks comprises:
a length section defining a length of a region occupied by the respective component block of the plurality of component blocks on the main memory;
a text section comprising the code components for providing the at least one firmware component or at least one application program component;
an input interface section defining which input interfaces are read out by the respective component block of the plurality of component blocks for reading input data;
an output interface section defining which output interfaces are written by the respective component block of the plurality of component blocks for outputting output data; and
a parameter section defining an execution frequency of the firmware components or application program components that can be provided by the respective component block of the plurality of component blocks and application memory request information defining which memory size is occupied on a RAM of the microcontroller during execution of a respective firmware component or application program component.

12. The method of claim 11, wherein when starting up the microcontroller, variables representing output data that can be output by a respective component block of the plurality of component blocks are written into the RAM of the microcontroller.

13. The method of claim 11, wherein when starting up the microcontroller, the following information is written into the RAM of the microcontroller for each of the plurality of component blocks, taking into consideration the respective memory management information:
a mapping structure defining at which locations of RAM output data that can be generated by the respective component block of the plurality of component blocks is written and an allocation in which memory regions of RAM input data required by the respective component block of the plurality of component blocks is stored;
a function sequence structure defining a respective sequence of functions to be processed by the processor to provide the firmware components or application program components which can be provided by the respective component block of the plurality of component blocks; and
for each firmware component or application program component of the respective component block of the plurality of component blocks, an output structure, defining output data to be written by the respective firmware component or application program component.

14. The method of claim 11, wherein a respective component block of the plurality of component blocks is granted direct hardware access to hardware components of the microcontroller.

15. The method of claim 11, wherein writing access to the RAM is restricted before executing the at least one firmware component or at least one application program component of a respective component block of the plurality of component blocks, such that only output data which can be output by the respective component block of the plurality of component blocks can be written into the RAM for the respective component block of the plurality of component blocks.

16. The method of claim 11, wherein the method is performed to carry out a software update of a program stored in the main memory of the microcontroller.

17. A microcontroller, comprising:
a main memory, wherein the microcontroller does not have a separate memory management unit, wherein a part of the main memory is occupied by a base firmware; and
a processor coupled to the main memory,
wherein the microcontroller is configured to write at least one component block into the main memory when the base firmware is inserted into the main memory, wherein the at least one component block comprises memory management information and code components for providing at least one firmware component or at least one application program component; and
wherein the processor is configured to, for changing at least one part of the code components of at least one component block, processes the memory management information and writes information to be written into the main memory at locations defined by the memory management information, and the memory management information of the changed at least one component block is updated.

18. The microcontroller of claim 17, wherein the at least one component block comprises a plurality of component blocks, wherein each of the plurality of component blocks comprises:
a length section defining a length of a region occupied by the respective component block of the plurality of component blocks on the main memory;
a text section comprising the code components for providing the at least one firmware component or at least one application program component;
an input interface section defining which input interfaces are read out by the respective component block of the plurality of component blocks for reading input data;
an output interface section defining which output interfaces are written by the respective component block of the plurality of component blocks for outputting output data; and
a parameter section defining an execution frequency of the firmware components or application program components that can be provided by the respective component block of the plurality of component blocks and application memory request information defining which memory size is occupied on a RAM of the microcontroller during execution of a respective firmware component or application program component.

19. A vehicle, comprising:
at least one microcontroller, which comprises
a main memory, wherein the microcontroller does not have a separate memory management unit, wherein a part of the main memory is occupied by a base firmware; and
a processor coupled to the main memory,
wherein the microcontroller is configured to write at least one component block into the main memory when the base firmware is inserted into the main memory, wherein the at least one component block comprises memory management information and code components for providing at least one firmware component or at least one application program component; and
wherein the processor is configured to, for changing at least one part of the code components of at least one component block, processes the memory management information and writes information to be written into the main memory at locations defined by the memory management information, and the memory management information of the changed at least one component block is updated.

20. The vehicle of claim 19, wherein the at least one component block comprises a plurality of component blocks, wherein each of the plurality of component blocks comprises:
a length section defining a length of a region occupied by the respective component block of the plurality of component blocks on the main memory;
a text section comprising the code components for providing the at least one firmware component or at least one application program component;
an input interface section defining which input interfaces are read out by the respective component block of the plurality of component blocks for reading input data;
an output interface section defining which output interfaces are written by the respective component block of the plurality of component blocks for outputting output data; and
a parameter section defining an execution frequency of the firmware components or application program components that can be provided by the respective component block of the plurality of component blocks and application memory request information defining which memory size is occupied on a RAM of the microcontroller during execution of a respective firmware component or application program component.
